(19) United States
(12) Patent Application Publication
(10) Pub. No.: US 2023/0180262 A1
(43) Pub. Date: Jun. 8, 2023

(54) User Equipment Power Savings in Monitoring Search Space

(71) Applicant: Huawei Technologies Co., Ltd., Shenzhen (CN)

(72) Inventors: Philippe Sartori, Plainfield, IL (US); Brian Classon, Palatine, IL (US); Diana Maamari, Palatine, IL (US)

(21) Appl. No.: 18/154,316

(22) Filed: Jan. 13, 2023

Related U.S. Application Data
(63) Continuation of application No. PCT/US2021/045036, filed on Aug. 6, 2021.
(60) Provisional application No. 63/062,306, filed on Aug. 6, 2020.

(51) Int. Cl. H04W 72/232

(52) U.S. Cl. CPC H04W 72/232

(57) ABSTRACT

Example methods and apparatus for reducing power consumption of user equipment (UE) are described. One example method includes receiving an indication by the UE for determining physical downlink control channel (PDCCH) candidate ordering for a plurality of PDCCH candidates in a PDCCH search space. The UE determines a first PDCCH candidate from among the plurality of PDCCH candidates based on the indication. In response to determining that downlink control information (DCI) for the UE is not found in the first PDCCH candidate, the UE determines a second PDCCH candidate from among the plurality of PDCCH candidates based on the indication. In response to determining that the DCI for the UE is found in the second PDCCH candidate, the UE processes the DCI.

### CROSS-REFERENCE TO RELATED APPLICATIONS

This application is a continuation of International Application No. PCT/US2021/045036, filed on Aug. 6, 2021, and entitled “User Equipment Power Savings in Monitoring Search Space,” which claims the benefit of U.S. Provisional Application No. 63/062,306, filed on Aug. 6, 2020, and entitled “Power Savings for RedCap UEs,” applications of which are hereby incorporated by reference in their entireties.

### TECHNICAL FIELD

The present disclosure relates generally to monitoring physical downlink control channel (PDCCH) search space, and in particular embodiments, to a system and method for reducing a user equipment's power consumption in monitoring the PDCCH search space.

### BACKGROUND

Reduced capability (RedCap) user equipments (UEs) are new radio (NR) entities that serve relatively low end services, but with requirements different than typical cellular UEs, such as long battery life. RedCap UEs are envisioned for at least three different scenarios: industrial sensors, video surveillance, and wearables.

Redcap UEs can be sensitive to power consumption in these scenarios. Some services (e.g., low latency ultra-reliable low-latency communication (URLLC) or extended reality (XR)) increase monitoring period and/or frequency for the UEs, thereby increasing the power consumption in monitoring the PDCCH search space.

### SUMMARY

The present disclosure is directed to methods and systems for monitoring PDCCH search space, and, in particular embodiments, to a system and method for reducing UE power consumption in monitoring PDCCH search space.

In a first implementation, a method for monitoring PDCCH search space includes: receiving, by a user equipment (UE), an indication for determining PDCCH candidate ordering for a plurality of PDCCH candidates in a PDCCH search space; determining, by the UE, a first PDCCH candidate from among the plurality of PDCCH candidates based on the indication; determining, by the UE, that downlink control information (DCI) for the UE is not found in the first PDCCH candidate; in response to determining that the DCI for the UE is not found in the first PDCCH candidate, determining, by the UE, a second PDCCH candidate from among the plurality of PDCCH candidates based on the indication; determining, by the UE, that the DCI for the UE is found in the second PDCCH candidate; and in response to determining that the DCI for the UE is found in the second PDCCH candidate, processing the DCI.

In a second implementation, an electronic device includes: at least one processor; and one or more memories coupled to the at least one processor and storing programming instructions for execution by the at least one processor to: receive an indication for determining PDCCH candidate ordering for a plurality of PDCCH candidates in a PDCCH search space; determine a first PDCCH candidate from among the plurality of PDCCH candidates based on the indication; determine that downlink control information (DCI) for the UE is not found in the first PDCCH candidate; in response to determining that the DCI for the UE is not found in the first PDCCH candidate, determine a second PDCCH candidate from among the plurality of PDCCH candidates based on the indication; determine that the DCI for the UE is found in the second PDCCH candidate; and in response to determining that the DCI for the UE is found in the second PDCCH candidate, process the DCI.

In a third implementation, a non-transitory computer-readable medium store programming instructions for execution by at least one processor to: receive an indication for determining PDCCH candidate ordering for a plurality of PDCCH candidates in a PDCCH search space; determine a first PDCCH candidate from among the plurality of PDCCH candidates based on the indication; determine that downlink control information (DCI) for the UE is not found in the first PDCCH candidate; in response to determining that the DCI for the UE is not found in the first PDCCH candidate, determine a second PDCCH candidate from among the plurality of PDCCH candidates based on the indication; determine that the DCI for the UE is found in the second PDCCH candidate; and in response to determining that the DCI for the UE is found in the second PDCCH candidate, process the DCI.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows an example wireless communication system;

FIG. 2 shows an example arrangement of PDCCH candidates in a search space;

FIG. 3 shows a flowchart illustrating an example process for monitoring PDCCH search space;

FIG. 4 shows a flowchart illustrating an example process for monitoring PDCCH search space based on aggregation levels;

FIG. 5 shows a flowchart illustrating an example process for monitoring PDCCH search space based on estimated SINR;

FIG. 6 shows a flowchart illustrating an example process for monitoring PDCCH search space; and

FIG. 7 shows a block diagram of an example computer system.

### DETAILED DESCRIPTION OF ILLUSTRATIVE EMBODIMENTS

The following detailed description describes monitoring PDCCH search space and reducing power consumption of UE in monitoring the search space and is presented to enable any person skilled in the art to make and use the disclosed subject matter in the context of one or more particular implementations.

Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail inasmuch as such details are within the skill of one of ordinary skill in the art. The present disclosure is not intended to be limited to the described or illustrated implementations, but to be accorded the widest scope consistent with the described principles and features.

PDCCH search space refers to the area in the downlink resource grid where PDCCH may be carried. The possible locations in the search space that may carry the PDCCHs are called PDCCH candidates. Each PDCCH carries one DCI and is identified by Radio Network Temporary Identifier (RNTI). The RNTI is implicitly encoded in the cyclic redundancy check (CRC) attachment of the DCI. UE may monitor the PDCCH search space and search this space to find the DCI. The UE may try to decode PDCCH/DCI using different values of parameters (e.g., CCE index, aggregation level, RNTI) based on a trial and error method (which is also known as blind decoding). Each blind decode consumes power, and the base station is free to dynamically select any particular blind decoding location to place the actual DCI. If there are X blind decodes per slot (e.g., 42), the UE may on average find the DCI after (X/2) of these decodes. Some UE types (e.g., RedCap) are more sensitive to power consumption.

Monitoring PDCCH candidates in the search space and searching the PDCCH candidates for the DCI can result in great UE power consumption. Traditional techniques for monitoring PDCCH candidates that reduce power consumption have relied on either reducing the monitoring periodicity of the PDCCH candidates or reducing the number of PDCCH candidates to monitor. However, reducing the monitoring periodicity or the number of the PDCCH candidates has proven to be suboptimal. For example, when reducing the number of PDCCH candidates, a chance of blocking can be increased, because the chances of overlap for two PDCCHs for two different UEs increases. Furthermore, the gains of reduced PDCCH monitoring are relatively small. Thus, there is a need for a technique for decreasing the power consumption in the monitoring.

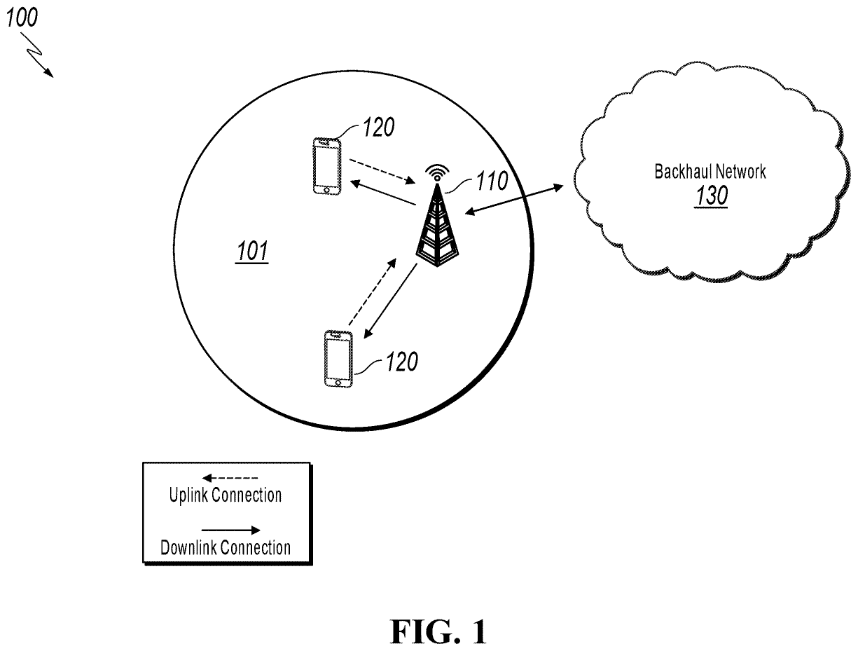

FIG. 1 shows an example wireless communication system 100. In some cases, the system 100 can be implemented to monitor a PDCCH search space. A UE may monitor the PDCCH search space and search the search space to find its DCI. As shown, the example system 100 includes a base station no with coverage area 101. The base station no serves a plurality of UEs, including UEs 120. A transmission from the base station no to a UE 120 is referred to as a downlink (DL) transmission and occurs over a downlink channel (shown in FIG. 1 as a solid arrowed line), while a transmission from a UE 120 to the base station no is referred to as an uplink (UL) transmission and occurs over an uplink channel (shown in FIG. 1 as a dashed arrowed line). Data carried over the uplink/downlink connections may include data communicated between the UEs 120, as well as data communicated to/from a remote-end (not shown) by way of a backhaul network 130. Example uplink channels and signals include physical uplink shared channel (PUSCH), physical uplink control channel (PUCCH), an uplink sounding reference signal (SRS), or physical random access channel (PRACH). Services may be provided to the plurality of UEs 120 by service providers (not shown) connected to the base station no through the backhaul network 13o, such as the Internet.

In some cases, an ordering of PDCCH candidates in the search space may be defined in the example system 100. The base station (e.g., base station no) and UE (e.g., UE 120) may both know the ordering the PDCCH candidates. The UE may search the PDCCH candidates following the ordering to find a DCI intended for the UE. In some cases, the UE does not expect to detect, in a same PDCCH monitoring occasion, more than one DCI. In some cases, preferred locations of candidates in the search space can be known to the base station and UE, and can be searched by the UE at a higher priority than other locations. As such, the DCI intended for the UE can be found faster as opposed to methods that require the UE to go through a long list of candidates, thereby reducing power consumption.

Turning to a more general description of the elements in the description, the term “base station” refers to any component (or collection of components) configured to provide wireless access to a network. Base stations may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, access nodes, access points, transmission points (TPs), transmission-reception points (TRPs), cells, carriers, macro cells, femtocells, pico cells, relays, customer premises equipment (CPE), the network side, the network, and so on.

As used herein, the term “UE” refers to any component (or collection of components) capable of establishing a wireless connection with a base station. UEs may also be commonly referred to as mobile stations, mobile devices, mobiles, terminals, user terminals, users, subscribers, stations, communication devices, CPEs, relays, Integrated Access and Backhaul (JAB) relays, and the like. It is noted that when relaying is used (based on relays, picos, CPEs, and so on), especially multi-hop relaying, the boundary between a controller and a node controlled by the controller may become blurry, and a dual node (e.g., either the controller or the node controlled by the controller) deployment where a first node that provides configuration or control information to a second node is considered to be the controller. Likewise, the concept of UL and DL transmissions can be extended as well.

A cell may include one or more bandwidth parts (BWPs) for UL or DL allocated for a UE. Each BWP may have its own BWP-specific numerology and configuration, such as the BWP's bandwidth. It is noted that not all BWPs need to be active at the same time for the UE. A cell may correspond to one carrier, and in some cases, multiple carriers. In some cases, one cell (a primary cell (PCell) or a secondary cell (SCell), for example) is a component carrier (a primary component carrier (PCC) or a secondary CC (SCC), for example). For some cells, each cell may include multiple carriers in UL, one carrier is referred to as an UL carrier or non-supplementary UL (non-SUL, or simply UL) carrier which has an associated DL, and other carriers are called supplementary UL (SUL) carriers which do not have an associated DL. A cell, or a carrier, may be configured with slot or subframe formats comprised of DL and UL symbols, and that cell or carrier is seen as operating in a time division duplexed (TDD) mode. In general, for unpaired spectrum, the cells or carriers are in TDD mode, and for paired spectrum, the cells or carrier are in a frequency division duplexed (FDD) mode. A transmission time interval (TTI) generally corresponds to a subframe (e.g., in LTE) or a slot (e.g., in NR). Access nodes may provide wireless access in accordance with one or more wireless communication protocols, e.g., long term evolution (LTE), LTE advanced (LTE-A), 5G, 5G LTE, 5G NR, future 5G NR releases, 6G, High Speed Packet Access (HSPA), Wi-Fi 802.11a/b/g/n/ac, etc. While it is understood that communication systems may employ multiple access nodes (or base stations) capable of communicating with a number of UEs, only one access node, and two UEs are illustrated in FIG. 1 for simplicity.

While elements of FIGS. 1-7 are shown as including various component parts, portions, or modules that implement the various features and functionality, nevertheless these-elements may instead include a number of submodules, third-party services, components, libraries, and such, as appropriate. Furthermore, the features and functionality of various components can be combined into fewer components as appropriate.

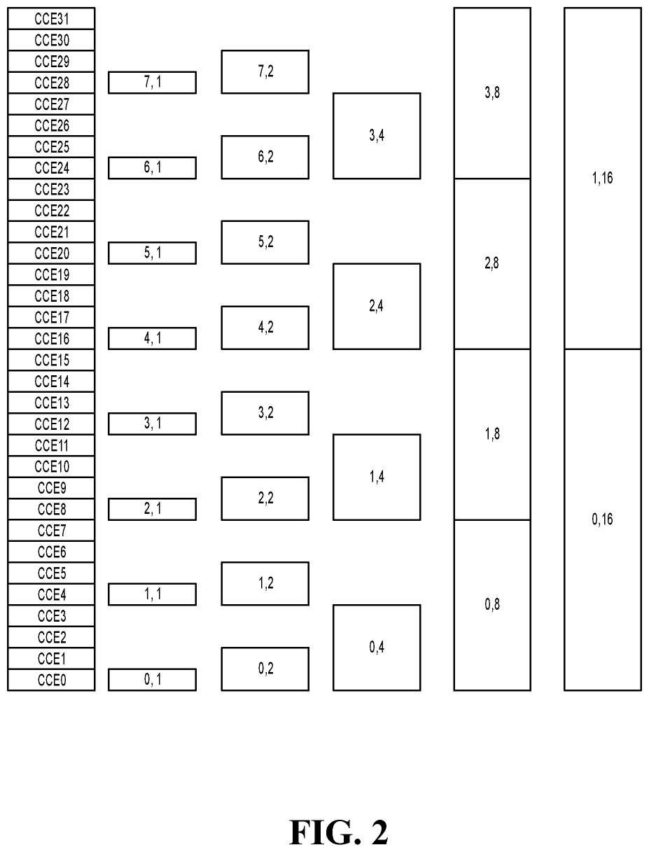

In some cases, PDCCH candidates in the PDCCH search space are organized in a specific manner. FIG. 2 shows an example arrangement of PDCCH candidates in the search space. In the example shown in FIG. 2, the PDCCH candidates can be listed as (a, b), where “a” represents a candidate index, and “b” represents an aggregation level. In the example, the numbers of PDCCH candidates for aggregation levels 1, 2, 4, 8, and 16 are 8, 8, 4, 4, and 2, respectively. As shown, the PDCCH candidates for aggregation level 1 include PDCCH candidates (0, 1), (1, 1), (2, 1), (3, 1), (4, 1), (5, 1), (6, 1), (7, 1), and (8, 1), and the PDCCH candidates for aggregation level 16 include candidates (o, 16) and (1,16). The left column of FIG. 2 is control channel element (CCE) indexes. As shown, for aggregation level 1, each PDCCH candidate has one CCE index. For example, candidate (0, 1) has index CCE0 and candidate (1, 1) has index CCE1. For aggregation level, 2, 4, or 8, each PDCCH candidate has more than one CCE index. For example, candidate (0, 2) has two indexes CCE0 and CCE1. Candidate (0, 8) has eight indexes CCE0-CCE7.

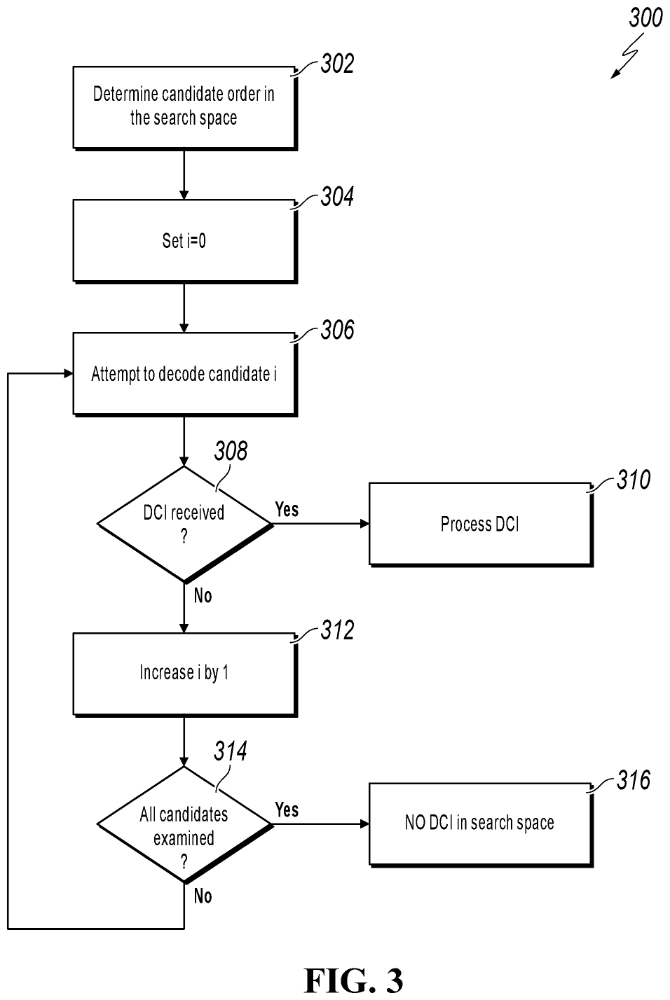

FIG. 3 shows a flowchart illustrating an example process 300 for monitoring PDCCH search space. In some cases, the process 300 may be implemented by a UE of a wireless communication system (e.g., UE 120 of system 100). In some cases, the process 300 can be implemented by any suitable devices. In general, an ordering for the PDCCH candidates is defined, and the UE sequentially goes through the PDCCH candidates based on the defined ordering until the UE finds one PDCCH candidate with a DCI intended for the UE, or until the UE has examined all the PDCCH candidates.

At step 302, a candidate order number is determined by a UE (e.g., UE 120) for each one of a plurality of PDCCH candidates in a predetermined search space. The candidate order number can be determined based on one or more factors, e.g., aggregation levels, candidate indexes, etc. The determination of the candidate order number will be discussed in greater detail below.

After determining the candidate order number, the UE determines a first candidate to be examined among the plurality of PDCCH candidates based on the candidate order number. In some cases, the UE sets a candidate counter that indicates the candidate order number of a PDCCH candidate to be examined. In some cases, the UE may determine to start with the first PDCCH candidate having the lowest candidate order number (e.g., 0), and set the candidate counter i to zero (step 304). The UE attempts to decode the PDCCH candidate (step 306) corresponding to value indicated by the candidate counter and determines whether the DCI is found in the decoded PDCCH candidate (step 308).

If it is determined that the DCI is found in the decoded PDCCH candidate, the UE continues to process the DCI (step 310). If the DCI is not found in the decoded PDCCH candidate, the UE increments the candidate counter, e.g., by 1 (step 312), and determines whether all candidates have been examined (step 314). In one example, the UE may determine whether all candidates have been examined by determining whether the value indicated by the candidate counter reaches a predetermined threshold of the number of the PDCCH candidates. If the UE determines that the PDCCH is not found in the most recently examined PDCCH candidate and that all PDCCH candidates have been examined, the UE may determine that no DCI is found in the search space (step 316). If the UE determines that there is remaining candidate(s) to be examined in the search space, the UE may continue to decode the next PDCCH candidate based on the candidate order number. In one example, the UE can continue to examine a PDCCH candidate having a candidate order number that matches the current value indicated by the candidate counter.

In some cases, the ordering of the PDCCH candidates are known to both the base station and UE so that both the base station and the UE are aware of the order of going through the PDCCH candidates.

In some cases, the ordering of the PDCCH candidates can be determined based on an indexing of the candidates. For each search space, an indexing of the candidates can be defined based on control channel element (CCE) indexes as follows.

For a search space set s associated with CORESET p, the CCE indexes for aggregation level L corresponding to PDCCH candidate m_{s,n}_{_{CI}} of the search space set in slot n_{s,f}^{μ} for an active DL BWP of a serving cell corresponding to carrier indicator field value n_{CI} are given by

$$L . \{ ( {Y}_{p , {n}_{s , f}^{u}} + [ \frac{{m}_{s , {n}_{CI}} \cdot {N}_{CCE , p}}{L \cdot {M}_{s , max}^{( L )}} ⌋ + {n}_{CI} ) mod [ {N}_{C C E , p} / L ] + i$$

where:
for any CSS, Y_{p,n}_{_{s,f}}^{μ}=0;
for a USS, Y_{p,n}_{_{s,f}}^{μ}=(Aₚ·Y_{p,n}_{_{s,f}}₋₁^{μ}) modD, Y_{p,-1}=n_{RNTI}≠0, Aₚ=39827 for pmod3=0, Aₚ=39829 for pmod3=1, Aₚ=39839 for pmod3=2, and D=65537;
i=0, . . . , L−1;
N_{CCE,p} is the number of CCEs, numbered from 0 to N_{CCE,p}−1, in CORESET p and, if any, per resource block (RB) set;
n_{CI} is the carrier indicator field value if the UE is configured with a carrier indicator field by CrossCarrierSchedulingConfig for the serving cell on which PDCCH is monitored; otherwise, including for any CSS, n_{CI}=0;
m_{s,n}_{_{CI}}=0, . . . , M_{s,n}_{_{CI}}^{(L)}−1, where M_{s,n}_{_{CI}}^{(L)} the number of PDCCH candidates the UE is configured to monitor for aggregation level L of a search space set s for a serving cell corresponding to n_{CI}.

The CCE index depends on C-RNTI and therefore is UE specific. In some cases, the CCE indexes can be used “as is” for determining the ordering of the PDCCH candidates. In some cases, the UE can start with a lowest CCE index value (e.g., 0) of a PDCCH candidate. In one example, and referring to FIG. 2, the UE can start from CCE0 of candidate (0, 1). In another example, and referring to FIG. 2, the UE can start from CCE16 of candidate (2, 4). In some cases, each candidate can have an index that is predefined in a technical specification (e.g., TS 38.213). This index could be used for the ordering of the PDCCH candidates. In some examples, the UE can start from the candidate with the lowest index value (e.g., 0).

In some cases, a pre-determined index value can be used to determine where to start monitoring the PDCCH search space. In some cases, a parameter U could be signaled to the UE (e.g., by RRC configuration). The UE can then start with candidate

$$⌊ \frac{U}{L} ⌋$$

for aggregation level L. In the case of a common search space, and without a UE-specific parameter, the PDCCH candidates can have the same index (as specified in TS38.213) for all UEs. Having a UE-specific parameter to determine the first candidate can make sure that each UE has a different starting point.

In some cases, preferred locations of candidates in the search space can be indicated to the base station and UE, and can be searched by the UE at a higher priority than other locations. In some cases, the preferred locations can indicate a target aggregation level (e.g., aggregation level 8, 4, 2, or 1). In one example, the UE can start from target aggregation level 8 to examine the PDCCH candidates in the search space.

In some cases, the preferred locations can indicate a preferred CCE index. In some examples, a target aggregation level may be associated with a predefined number of CCEs and the preferred CCE index may be different for different aggregation levels.

In some cases, the preferred CCE index and target aggregation level may be used in combination to determine the candidate ordering. The UE may go through the candidates in the first slot starting from the target aggregation level and the preferred CCE index. For the rest of the slots, the UE may start with the same target aggregation level and same preferred CCE index in a second slot as start to find the DCI.

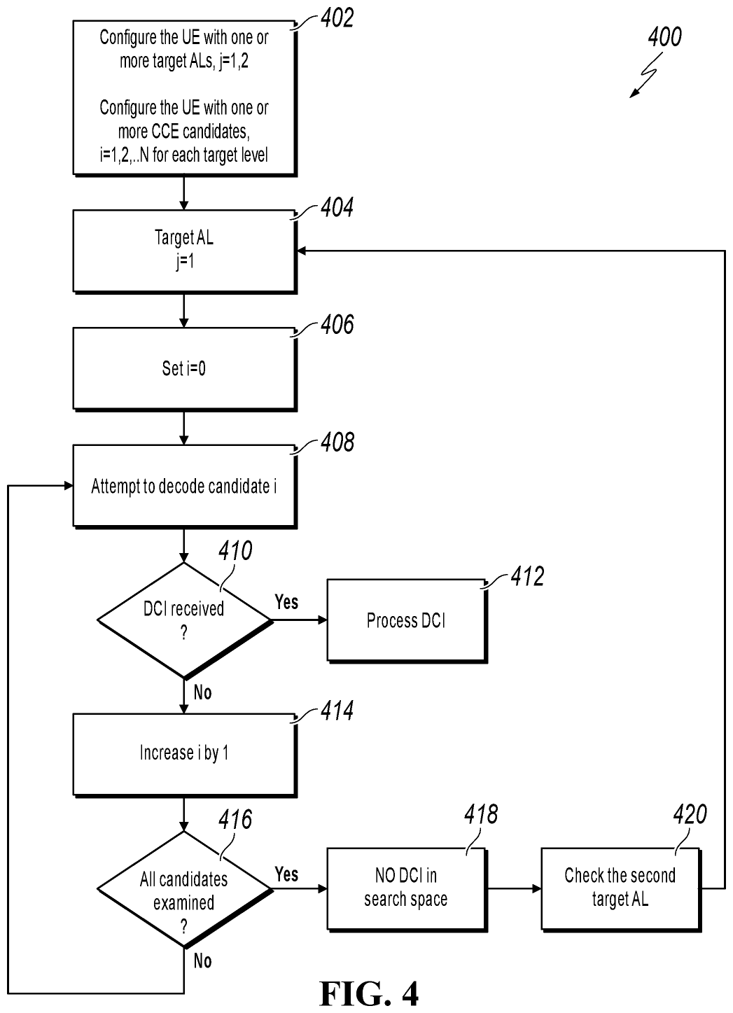

FIG. 4 shows a flowchart illustrating an example process 400 for monitoring PDCCH search space based on aggregation levels. In some cases, the process 400 may be implemented by a UE of a wireless communication system (e.g., UE 120 of system 100). In some cases, the process 400 may be implemented by any suitable devices. In general, a UE may be configured with one or more target aggregation levels (ALs) that assists the UE to use the target ALs as a priority to look up the DCI in the search space. If the DCI is found, the UE stops the search.

At step 402, a UE (e.g., UE 120) is configured with one or more target ALs and one or more CCE candidates for each target AL. In some cases, and as described herein, CCE candidates indicate CCE locations where the UE may find the PDCCH/DCI intended for the UE. Each CCE candidate is associated with a CCE index. In one example, the UE may be configured with two target ALs and use the two target ALs as priority ALs. In this example, if the DCI is not found for a first target AL of the two target ALs, the UE can continue to use the second target AL to search for the DCI. If the DCI is still not found for the second target AL, the UE can continue to look through other ALs.

In some cases, each of the target ALs is associated with an AL index number and each of the CCE candidates is associated with a CCE candidate number. The UE can set a target AL counter that indicates an AL index number of a target AL to be examined. The UE can set a CCE candidate counter that indicates a CCE candidate number of a CCE candidate to be examined. The UE can use the target AL counter and the CCE candidate counter to examine the candidates in the search space.

In some cases, the UE may determine to start from a first target AL having a lowest AL index number (e.g., 1) among the one or more target ALs, and set the target AL counter to one (j=1) (step 404). After determining the first target AL, the UE may determine to start from a first CCE candidate having lowest CCE candidate number (e.g., 0) among the one or more CCE candidates for the first target AL, and set the CCE candidate counter to zero (i=0) (step 406).

After determining the first CCE candidate for the first target AL, the UE decodes the first CCE candidate (step 408) and determines whether the DCI is found in the first CCE candidate (step 410). If the DCI is found in the first CCE candidate, the UE continues to process the DCI (step 412). If the DCI is not found in the first CCE candidate, the UE increments the CCE candidate counter, e.g. by 1 (step 414), and determines whether all CCE candidates have been examined for the first target AL (step 416). In this example, the UE may determine whether the CCE candidate counter reaches a predetermined threshold. If the UE determines that not all candidates have been examined and there is remaining CCE candidate(s) to be examined for the first target AL, the UE continues to examine the next CCE candidate in the first target AL. If the UE has examined all CCE candidates for the first target AL, the UE determines that no DCI is found for the first target AL in the search space (418), and continues to check the second target AL for the DCI (step 420), which includes repeating steps 404-418 for the second target AL.

In some cases, the UE may monitor the PDCCH search space by starting from a certain aggregation level based on estimated signal-to-interference-plus-noise ratio (SINR). In one example, a UE may attempt to find candidates based on an aggregation level corresponding to the radio conditions (e.g., a UE operating at odB SINR is unlikely to use aggregation level 1). In some cases, a look-up table to indicate which aggregation level to monitor can be defined. Table 1 is an example look-up table showing a correspondence between SINR and aggregation level to monitor.

TABLE 1

| | Aggregation level |
|---|---|
| SINR | to monitor first |
| SINR < T0 | 16 |
| T0 ≤ SINR < T1 | 8 |
| T1 ≤ SINR < T2 | 4 |
| T2 ≤ SINR < T3 | 2 |
| T3 ≤ SINR < T4 | 1 |

The parameters T0, T1, T2, T3, and T4 need to be known at both the base station and the UE. To a large extent, they depend on the base station transmission parameters and UE reception parameters (e.g., number of antennas). Consequently, they should be link-specific. There are several ways to obtain those parameters: (1) by RRC signaling that the base station sends to the UE (dedicated or common RRC signaling); (2) based on the UE features (capabilities); (3) based on hard coded values specified in the standards specification; or (4) based on the measurement used for determining the aggregation level, which could be any indicator linked to radio conditions such as RSRP, RSRQ, RSSI, SNR, SINR, etc.

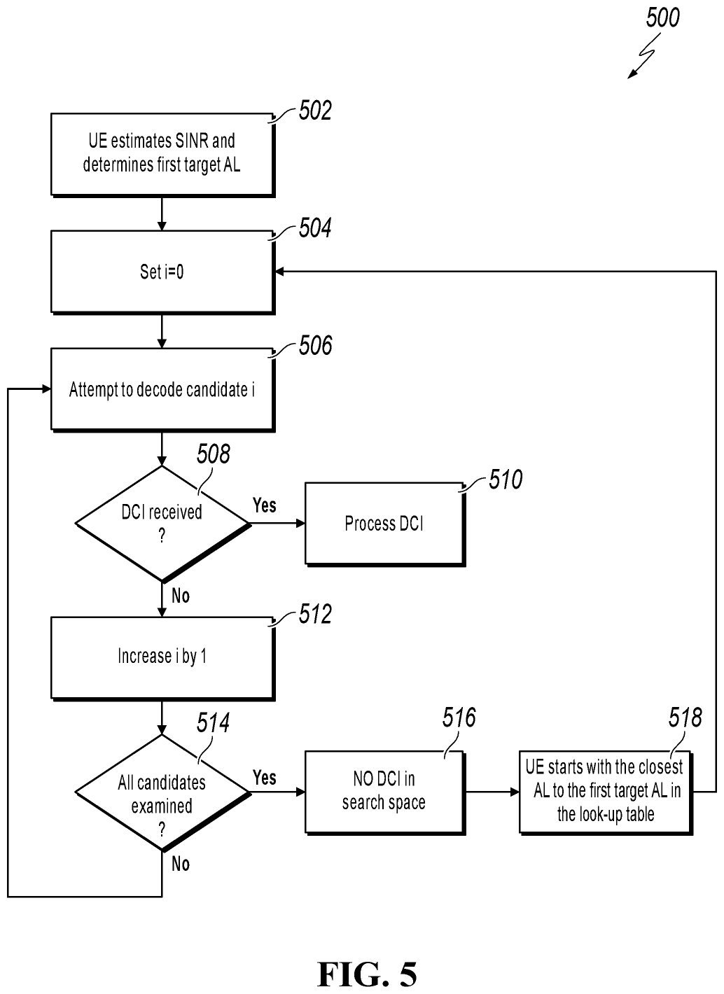

FIG. 5 shows a flowchart illustrating an example process 500 of monitoring PDCCH search space based on estimated SINR. In some cases, the process 500 may be implemented by a UE of a wireless communication system (e.g., UE 120 of system 100). In some cases, the process 500 may be implemented by any suitable devices.

At step 502, a UE (e.g., UE 120) estimates the SINR and determines a first target AL based on the estimated SINR. In some cases, the UE can store a look-up table (e.g., Table 1) that indicates a correspondence between multiple SINR ranges and multiple target aggregation levels. In one example, the look-up table may indicate that higher ALs may be first targeted by the UE for lower SINRs. The UE may determine the first target AL based on the estimated SINR and the look-up table.

After determining the first target AL, the UE determines a first PDCCH candidate to search for the DCI (step 504). In some examples, the UE may determine the first PDCCH candidate based on index number of the PDCCH candidates for the first target AL. The UE may determine the first PDCCH candidate as a PDCCH candidate with the lowest index number (e.g., index number i=0). In some cases, the UE may set a candidate counter to indicate the number of the PDCCH candidates that have been examined.

The UE decodes the first PDCCH candidate (step 506) and determines whether the first PDCCH candidate includes the DCI for the UE (step 508). If the DCI is found in the first PDCCH candidate, the UE proceeds to process the DCI (step 510).

If the DCI is not found in the first PDCCH candidate, the UE continues to search the next PDCCH for the DCI. In one example, the UE may search a second PDCCH candidate with a second lowest index number (e.g., index number i=1). The UE can update the candidate counter, for example, by incrementing the candidate counter by 1 (step 512). The UE continues to determine whether all candidates have been examined for the first target AL (step 514). In one example, the UE can determine whether all candidates have been examined by determining whether the candidate counter value reaches a predetermined threshold of the number of candidates for the target AL. If the UE determines that now all candidates have been examined and that there is still remaining candidate(s) to be examined for the target AL, the UE continues to examine the next PDCCH based on the updated candidate counter. If the UE determines that all candidates have been examined for the first target AL and that no DCI is found, the UE determines no DCI is found in the search space for the first target AL (step 516). Then, the UE continues to examine with the closest AL to the first target AL in the look-up table (step 518). In one example, if the first target AL is AL 8, the second target AL can be AL₄. In some cases, the UE resets the candidate counter before proceeding to examining the candidates for next AL. In some cases, if no DCI is found for a second AL that is closest to the first target AL, the UE may continue to examine with the closest AL to the second AL. Alternatively, in some case, if no DCI is found for the second AL that is closest to the first target AL, the UE may check the remaining candidates in any suitable ordering.

In some cases, when the UE has obtained a PDCCH in an earlier slot, it can keep track of the aggregation level and candidate number. For future PDCCH search, the UE may start its search with the aggregation level and candidate ordering of the previous successful PDCCCH decoding attempt. Alternatively, in some cases, the UE may only start with the aggregation level of the previously decoded PDCCH.

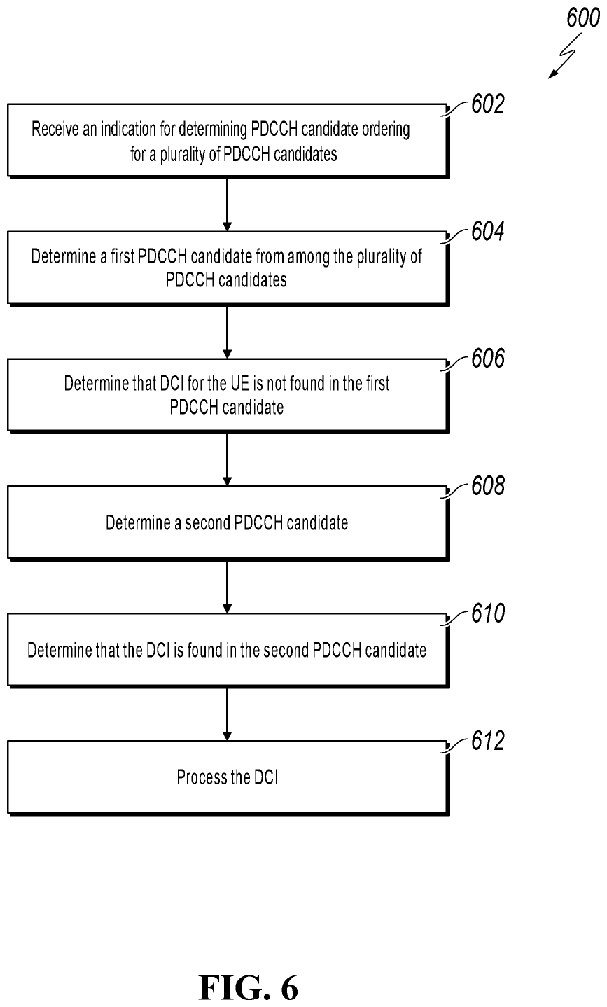

FIG. 6 shows a flowchart illustrating an example process 600 for monitoring PDCCH search space. In some cases, the process 600 may be implemented by a UE of a wireless communication system (e.g., UE 120 of system 100). In some cases, the process 600 may be implemented by any suitable devices.

At step 602, a UE (e.g., UE 120) receives an indication or signaling for determining PDCCH candidate ordering for a plurality of PDCCH candidates in a PDCCH search space. In some cases, the indication includes at least one of the following: a target aggregation level, a start CCE index among a plurality of CCE indexes for the PDCCH search space, or a UE-specific parameter. In some cases, the indication is sent in RRC configuration from a base station (e.g., base station no). The information of the indication can be determined based on an estimation of signal-to-interference-plus-noise ratio (SINR) by the UE. In one example, the indication may include a target aggregation level that is determined based on a look-up table (e.g., Table 1) and an estimated SINR. In some cases, the PDCCH candidate ordering indicates a preferred location of the PDCCH candidate (e.g., target aggregation level or CCE index) in the PDCCH search space, and each PDCCH candidate is associated with one or more CCE indexes. The information of the indication may comprise preferred locations of the PDCCH candidates that are pre-defined in a technical specification.

At step 604, the UE determines a first PDCCH candidate from among the plurality of PDCCH candidates based on the indication. In some cases, the UE determines an index number for each PDCCH candidate from among the plurality of PDCCH candidates. The UE continues to determine the first PDCCH candidate based on the index number. In one example, the first PDCCH candidate is determined based on the index number for each PDCCH candidate, where the first PDCCH candidate has a lowest index number among the plurality of PDCCH candidates.

In some cases, the UE determines the first PDCCH candidate based on at least one of an aggregation level order or a control channel element (CCE) order. In some cases, the UE receives a radio resource control (RRC) parameter from a base station, where the RRC parameter indicates one or more target aggregation levels. The one or more target aggregation levels are the aggregation levels that the UE should use to examine the candidates first. In some cases, the UE determines the first PDCCH candidate based on an ordering of the one or more target aggregation levels. In some cases, the UE may examine the candidates from a target aggregation level with the highest order among the one or more target aggregation levels. In one example, the UE may determine to examine from AL order 16 first among AL orders 16, 8, 4, 2, and 1.

In some cases, the UE determines an estimated signal-to-interference-plus-noise ratio (SINR). A target aggregation level is determined by the UE based on a predetermined mapping relationship between a plurality of estimated SINRs and a plurality of target aggregation levels. The UE determines the first PDCCH candidate at the target aggregation level.

After determining the first PDCCH candidate, the UE continues to determine whether DCI for the UE is found in the first PDCCH candidate. At step 606, the UE determines that the DCI for the UE is not found in the first PDCCH candidate. In response to determining that the DCI for the UE is not found in the first PDCCH candidate, the UE determines a second PDCCH candidate from among the plurality of PDCCH candidates based on the indication (step 608). In some cases, the second PDCCH candidate has a second index number that is higher than a first index number of the first PDCCH candidate. In some cases, the second PDCCH candidate from among the plurality of PDCCH candidates based on the indication is from the remaining candidates that cannot be determined as the first PDCCH candidate from among the plurality of PDCCH candidates based on the indication.

Then, the UE determines that whether the DCI for the UE is found in the second PDCCH candidate. At step 610, the UE determines that the DCI is found in the second PDCCH candidate. Then, the UE continues to process the DCI in response to determining that the DCI for the UE is found in the second PDCCH candidate (step 612). If the DCI is not found in the second PDCCH candidate, the UE will continue to examine the remaining PDCCH candidate(s) based on the PDCCH candidate ordering until the DCI is found or all candidates have been examined.

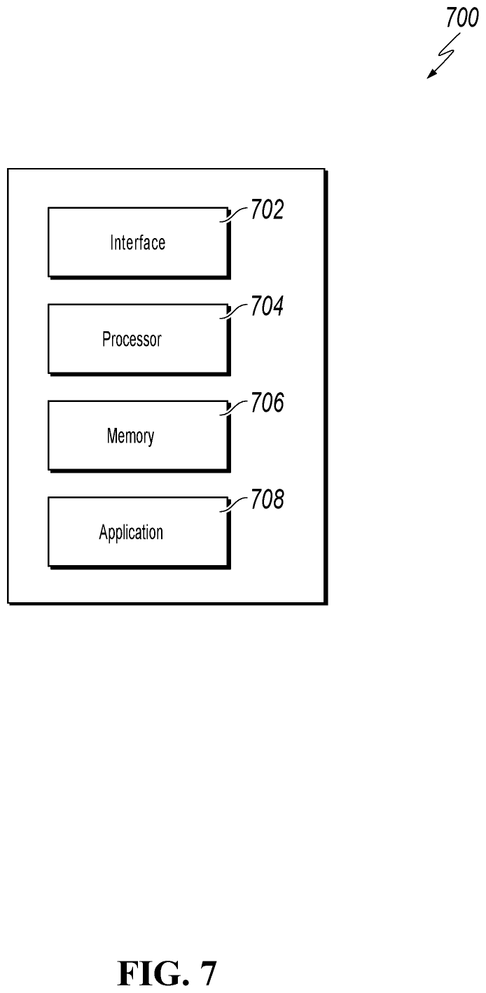

FIG. 7 is a block diagram of an example computer system 700 used to provide computational functionalities associated with described algorithms, methods, functions, processes, flows, and procedures, as described in the instant disclosure, according to an implementation. The computer system 700, or more than one computer system 700, can be used to implement the electronic devices described previously in this disclosure, e.g., UE, eNB, gNB, or other network nodes. In some cases, the computer system 700 can be implemented as any one of the UEs 120 and the base station no of FIG. 1.

In some aspects, the computer system 700 may comprise a computer that includes an input device, such as a keypad, keyboard, touch screen, or other device that can accept user information, and an output device that conveys information associated with the operation of the computer system 700, including digital data, visual, or audio information (or a combination of information), or a graphical user interface (GUI).

The computer system 700 can serve in a role as a client, network component, a server, a database or other persistency, or any other component (or a combination of roles) of a computer system for performing the subject matter described in the instant disclosure. In some implementations, one or more components of the computer system 700 may be configured to operate within environments, including cloud-computing-based, local, global, or other environment (or a combination of environments).

At a high level, the computer system 700 is an electronic computing device operable to receive, transmit, process, store, or manage data and information associated with the described subject matter. According to some implementations, the computer system 700 may also include, or be communicably coupled with, an application server, e-mail server, web server, caching server, streaming data server, or other server (or a combination of servers).

The computer system 700 can receive requests over a network from a client application and respond to the received requests by processing the received requests using an appropriate software application(s). In addition, requests may also be sent to the computer system 700 from internal users (for example, from a command console or by other appropriate access methods), external or third-parties, other automated applications, as well as any other appropriate entities, individuals, systems, or computers.

The computer system 700 includes an interface 702. Although illustrated as a single interface 702 in FIG. 7, two or more interfaces 702 may be used according to particular needs, desires, or particular implementations of the computer system 700. The interface 702 is used by the computer system 700 for communicating with other systems that are connected to the network (whether illustrated or not) in a distributed environment. Generally, the interface 702 includes logic encoded in software or hardware (or a combination of software and hardware) and is operable to communicate with the network. More specifically, the interface 702 may include software supporting one or more communication protocols associated with communications such that the interface's hardware is operable to communicate physical signals within and outside of the illustrated computer system 700.

The computer system 700 includes a processor 704. Although illustrated as a single processor 704 in FIG. 7, two or more processors may be used according to particular needs, desires, or particular implementations of the computer system 700. Generally, the processor 704 executes instructions and manipulates data to perform the operations of the computer system 700 and any algorithms, methods, functions, processes, flows, and procedures as described in the instant disclosure.

The computer system 700 also includes a memory 706 that can hold data for the computer system 700 or other components (or a combination of both) that can be connected to a network (whether illustrated or not). For example, memory 706 can be Random Access Memory (RAM), Read Only Memory (ROM), optical, magnetic, and the like, storing data consistent with this disclosure. In some implementations, memory 706 can be a combination of two or more different types of memory (for example, a combination of RAM and magnetic storage) according to particular needs, desires, or particular implementations of the computer system 700 and the described functionality. Although illustrated as a single memory 706 in FIG. 7, two or more memories 706 (of the same or a combination of types) can be used according to particular needs, desires, or particular implementations of the computer system 700 and the described functionality. While memory 706 is illustrated as an integral component of the computer system 700, in alternative implementations, memory 706 can be external to the computer system 700.

The application 708 is an algorithmic software engine providing functionality according to particular needs, desires, or particular implementations of the computer system 700, particularly with respect to functionality described in this disclosure. For example, application 708 can serve as one or more components, modules, or applications. Further, although illustrated as a single application 708, the application 708 may be implemented as multiple applications 708 on the computer system 700. In addition, although illustrated as integral to the computer system 700, in alternative implementations, the application 708 can be external to the computer system 700.

There may be any number of computer systems 700 associated with, or external to, a computer system containing computer system 700, each computer system 700 communicating over a network. Further, the term “client,” “user,” and other appropriate terminology may be used interchangeably, as appropriate, without departing from the scope of this disclosure. Moreover, this disclosure contemplates that many users may use one computer system 700, or that one user may use multiple computer systems 700.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a Central Processing Unit (CPU), a Field Programmable Gate Array (FPGA), or an Application-specific Integrated Circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a ROM or a Random Access Memory (RAM), or both. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a Personal Digital Assistant (PDA), a mobile audio or video player, a game console, a Global Positioning System (GPS) receiver, or a portable storage device, for example, a Universal Serial Bus (USB) flash drive, to name just a few.

Computer readable media (transitory or non-transitory, as appropriate) suitable for storing computer program instructions and data includes non-volatile memory, media and memory devices, including by way of example, semiconductor memory devices, for example, Erasable Programmable Read-Only Memory (EPROM), Electrically Erasable Programmable Read-Only Memory (EEPROM), and flash memory devices; magnetic disks, for example, internal hard disks or removable disks; magneto optical disks; and CD ROM, DVD+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a Cathode Ray Tube (CRT), Liquid Crystal Display (LCD), Light Emitting Diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back end, middleware, or front end components. The components of the system can be interconnected by any form or medium of wireline or wireless digital data communication (or a combination of data communication), for example, a communication network. Examples of communication networks include a Local Area Network (LAN), a Radio Access Network (RAN), a Metropolitan Area Network (MAN), a Wide Area Network (WAN), Worldwide Interoperability for Microwave Access (WIMAX), a Wireless Local Area Network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A method, comprising:
receiving, by a user equipment (UE), an indication for determining a physical downlink control channel (PDCCH) candidate ordering for a plurality of PDCCH candidates;
determining, by the UE, a first PDCCH candidate from the plurality of PDCCH candidates based on the indication;
determining, by the UE, that a downlink control information (DCI) for the UE is not found in the first PDCCH candidate;
in response to the determining that the DCI for the UE is not found in the first PDCCH candidate, determining, by the UE, a second PDCCH candidate from the plurality of PDCCH candidates based on the indication;
determining, by the UE, that the DCI for the UE is found in the second PDCCH candidate; and
in response to the determining that the DCI for the UE is found in the second PDCCH candidate, processing the DCI.

2. The method of claim 1, wherein the indication is based on one of:
a radio resource control (RRC) configuration sent by a base station,
an estimation of a signal-to-interference-plus-noise ratio (SINR) by the UE, or the indication being pre-defined in a specification.

3. The method of claim 1, wherein the PDCCH candidate ordering indicates a preferred location of a PDCCH candidate in a PDCCH search space, and wherein each of the plurality of PDCCH candidates is associated with one or more corresponding control channel element (CCE) indexes.

4. The method of claim 1, wherein the indication comprises at least one of:
a target aggregation level,
a start CCE index among a plurality of CCE indexes for a PDCCH search space, or a UE-specific parameter.

5. The method of claim 1, wherein the determining the first PDCCH candidate from the plurality of PDCCH candidates based on the indication comprises:
determining, by the UE, a corresponding index number for each PDCCH candidate from the plurality of PDCCH candidates; and
determining, by the UE, the first PDCCH candidate based on the corresponding index number for each PDCCH candidate, wherein the first PDCCH candidate has a lowest index number among the plurality of PDCCH candidates.

6. The method of claim 5, wherein the determining the second PDCCH candidate from the plurality of PDCCH candidates based on the indication comprises:
determining, by the UE, the second PDCCH candidate based on the corresponding index number for each PDCCH candidate, wherein the second PDCCH candidate has a second index number that is higher than a first index number of the first PDCCH candidate.

7. The method of claim 1, wherein the determining the first PDCCH candidate from among the plurality of PDCCH candidates based on the indication comprises:
determining the first PDCCH candidate based on at least one of an aggregation level order or a CCE order.

8. The method of claim 1, further comprising:
receiving, by the UE, an RRC parameter from a base station, the RRC parameter indicating one or more target aggregation levels.

9. The method of claim 8, wherein the determining the first PDCCH candidate from the plurality of PDCCH candidates based on the indication comprises:
determining, by the UE, the first PDCCH candidate based on an ordering of the one or more target aggregation levels.

10. The method of claim 1, wherein the determining the first PDCCH candidate from the plurality of PDCCH candidates based on the indication comprises:
determining, by the UE, an estimated signal-to-interference-plus-noise ratio (SINR);
determining, by the UE, a target aggregation level based on a predetermined mapping relationship between a plurality of estimated SINRs and a plurality of target aggregation levels; and
determining, by the UE, the first PDCCH candidate at the target aggregation level.

11. An apparatus, comprising:
at least one processor; and
one or more memories coupled to the at least one processor and storing programming instructions for execution by the at least one processor to cause the apparatus to perform operations including:
receiving, by a user equipment (UE), an indication for determining a physical downlink control channel (PDCCH) candidate ordering for a plurality of PDCCH candidates;
determining a first PDCCH candidate from the plurality of PDCCH candidates based on the indication;
determining that a downlink control information (DCI) for the UE is not found in the first PDCCH candidate;
in response to the determining that the DCI for the UE is not found in the first PDCCH candidate, determining a second PDCCH candidate from the plurality of PDCCH candidates based on the indication;
determining that the DCI for the UE is found in the second PDCCH candidate; and
in response to the determining that the DCI for the UE is found in the second PDCCH candidate, processing the DCI.

12. The apparatus of claim 11, wherein the indication is based on one of:
a radio resource control (RRC) configuration sent by a base station,
an estimation of a signal-to-interference-plus-noise ratio (SINR) by the UE, or the indication being pre-defined in a specification.

13. The apparatus of claim 11, wherein the PDCCH candidate ordering indicates a preferred location of a PDCCH candidate in a PDCCH search space, and wherein each of the plurality of PDCCH candidates is associated with one or more corresponding control channel element (CCE) indexes.

14. The apparatus of claim 11, wherein the indication comprises at least one of:
a target aggregation level,
a start CCE index among a plurality of CCE indexes for a PDCCH search space, or
a UE-specific parameter.

15. The apparatus of claim 11, wherein the determining the first PDCCH candidate from the plurality of PDCCH candidates based on the indication comprises:
determining a corresponding index number for each PDCCH candidate from the plurality of PDCCH candidates; and
determining the first PDCCH candidate based on the corresponding index number for each PDCCH candidate, wherein the first PDCCH candidate has a lowest index number among the plurality of PDCCH candidates.

16. A non-transitory computer-readable medium having instructions stored thereon that, when executed by an apparatus, cause the apparatus to perform operations, the operations comprising:
receiving, by a user equipment (UE), an indication for determining a physical downlink control channel (PDCCH) candidate ordering for a plurality of PDCCH candidates;
determining a first PDCCH candidate from the plurality of PDCCH candidates based on the indication;
determining that a downlink control information (DCI) for the UE is not found in the first PDCCH candidate;
in response to the determining that the DCI for the UE is not found in the first PDCCH candidate, determining a second PDCCH candidate from the plurality of PDCCH candidates based on the indication;
determining that the DCI for the UE is found in the second PDCCH candidate; and
in response to the determining that the DCI for the UE is found in the second PDCCH candidate, processing the DCI.

17. The non-transitory computer-readable medium of claim 16, wherein the indication is based on one of:
a radio resource control (RRC) configuration sent by a base station,
an estimation of a signal-to-interference-plus-noise ratio (SINR) by the UE, or
the indication being pre-defined in a specification.

18. The non-transitory computer-readable medium of claim 16, wherein the PDCCH candidate ordering indicates a preferred location of a PDCCH candidate in a PDCCH search space, and wherein each of the plurality of PDCCH candidates is associated with one or more corresponding control channel element (CCE) indexes.

19. The non-transitory computer-readable medium of claim 16, wherein the indication comprises at least one of:
a target aggregation level,
a start CCE index among a plurality of CCE indexes for a PDCCH search space, or
a UE-specific parameter.

20. The non-transitory computer-readable medium of claim 16, wherein the determining the first PDCCH candidate from the plurality of PDCCH candidates based on the indication comprises:
determining a corresponding index number for each PDCCH candidate from the plurality of PDCCH candidates; and
determining the first PDCCH candidate based on the corresponding index number for each PDCCH candidate, wherein the first PDCCH candidate has a lowest index number among the plurality of PDCCH candidates.
